(19) United States
(12) Patent Application Publication
(10) Pub. No.: US 2008/0215273 A1
(43) Pub. Date: Sep. 4, 2008

(54) Authentication Method Secured By Chemical Marking Or Tracing Of An Object Or Substance

(76) Inventors: Claude Lambert, Saint Michel sur Orge (FR); Jean-Michael Hachin, Levallois Perret (FR)

Correspondence Address: BROWDY AND NEIMARK, P.L.L.C.;624 NINTH STREET, NW, SUITE 300, WASHINGTON, DC, 20001-5303, US

(21) Appl. No.: 11/579,035

(22) PCT Filed: Apr. 21, 2005
(86) PCT No.: PCT/FR2005/001013

§ 371 Date: Sep. 12, 2007

(30) Foreign Application Priority Data
Apr. 28, 2004 (FR) 0404509

(51) Int. Cl. G06F 19/00

(52) U.S. Cl. 702/82

(57) ABSTRACT

The invention concerns a method comprising an identification and an authentication phase including a theoretical identification of an object, a spectrophotometric analysis of the object, determining a marker used as standard, comparing data concerning said standard marker obtained during the spectrophotometric analysis with said specific data previously stored, calculating the correction to be brought to the analysis, detecting the presence, absence, intensity of the markers, determining the code authenticating the object and emitting a validation or alarm signal as the case may be.

The present invention relates to an authentication method secured by chemical marking or tracing of objects or substances. It applies more particularly, but not exclusively, to the struggle against the counterfeiting, to automatic screening.

In general, numerous objects or substances in transit or proposed for sale are identified by means of a bar code. This code helps to define products but it is not enough to authenticate them, that is, to certify after analysis that the object or the substance is the one defined by the bar code.

In an effort to solve this problem, processes integrating a chemical marker in objects or substances have been created. However, it is necessary to turn to laboratories to perform analysis and to detect counterfeit products: this procedure is much too long and complicated.

As for the solution consisting of developing analysis equipment specific to each product, this is not economically viable.

The object of the invention is to solve these disadvantages by proposing to make use of only one apparatus for a multiplicity of products.

To this end, the applicants have proposed an authentication method for different objects or substances to be identified comprising at least two following successive phases:
An initial phase comprising:
   selection of a plurality of chemical markers which, when excited by incident light radiation, emit energetic radiations whereof the frequency spectra are discernible relative to one another and relative to the objects and substances in which they are intended to be incorporated,
   attribution then incorporation in each of the objects or substances of a combination of previously selected markers different to those attributed to the other objects,
   setting up an authentication code determined by parameters relative to the presence or the absence of the markers in the attributed combinations,
   storing in memory of an information system of the authentication code of all the objects or substances and associated data corresponding to these objects or these substances,
   assignment to the object or the substance of an identification code, such as a bar code or similar, this identification code capable of being associated with the object, the substance, its container, and/or its packaging,
   storing in memory in said system of the identification codes of each of the objects,
   setting up a correspondence between the identification codes and the authentication codes.
An identification and authentication phase by said system, this phase comprising:
   theoretical identification of the object or the substance by reading the identification code associated with the object,
   spectrophotometric analysis of at least part of the object or the substance so as to detect the abovementioned parameters, especially the presence or the absence of markers and determination of the authentication code of the object or the substance,
   authentication of the object in the event where the theoretical identification code corresponds to the authentication code,
   emission of a validation signal in the event where correspondence has been detected or an alert signal in the event where the authentication code does not correspond with the identification code.

In this process, the spectrophotometric analysis phase comprises the following stages:
irradiation of the object or the marked substance by means of a wide-frequency spectrum light beam,
sending waves transmitted or reflected by the object or the substance emitted by a generator on a dispersive element which deviates it so as to produce a light spectrum of the light intensity in different zones of the spectrum corresponding to ranges of different wavelengths,
detection of the light intensity in each of the zones,
comparison of this intensity with one or more threshold values specifically attributed to this zone and which are registered in memory by way of the abovementioned parameters,
result of this comparison contributing to determination of the authentication code of the object.

Advantageously, determination of the zones of the spectrum to be analysed, as for the different parameters assigned to each of these zones, is undertaken by the system from identification data. This solution produces greater reliability of the results and considerably alleviates the power of the processing means utilised.

The parameters relating to the presence or the absence of the markers in the attributed combination and utilised for determination of an identification and/or authentication code comprise especially:
the presence or not of fluorescence,
duration of fluorescence greater or less than at least one threshold value,
the presence or the absence of a peak having a preset wavelength as well as, optionally, the amplitude and/or the width of this peak,
heights of emission peak corresponding to a concentration in markers greater or less than one or more predefined threshold values.

To increase the number of possible combinations, different concentrations of markers are utilised to obtain different intensity stripes.

In addition, in order to avoid all the optical factors likely to perturb reading and subsequent spectrophotometric analysis, it was proposed to control the light intensity emitted by the generator of light radiation as a function of the spread between the value of the light intensity detected in a predetermined frequency range not affected by the presence of the markers and a predetermined deposit value.

This measure proves necessary when a number of levels of intensity is used as parameters.

The aim of the invention more particularly is to better secure the authentication method previously described above.

For this purpose, it proposes using a plurality of chemical markers whereof the presence and the absence help set up an authentication code of a multiplicity of different objects, each type of object having, at any given instant, a specific authentication code.

According to the invention, at least one of said markers is utilised as standard measure serving as reference for determination of the presence, the absence and/or the intensity of the other markers, especially in light of making corrections and calibrations avoiding noises capable for example of originating from the composition of the substance or the object, positioning variations such as the angle of incidence, the distance from the object or transparent material enveloping or surrounding this substance or this object, or a decrease in the signal due to the presence of foreign bodies (fouling, . . . ) or possible decrease in the signal resulting from prolonged exposure to bad weather or ageing of the object.

As a consequence, the method according to the invention also comprises:
prior selection of one of the abovementioned markers and attribution of this marker as a standard measure to a type of product or substance and/or for a predetermined period of time,
assignment to this marker of identification data and data specific to its function as standard measure and storing of these data,
during an authentication phase, determination of the marker utilised as a standard measure, from previously stored identification data, comparison of data relative to this standard measure marker obtained during spectrophotometric analysis of the object or the substance, with the abovementioned previously stored specific data,
calculation of correction to be contributed to spectrophotometric analysis from the result of this comparison,
detection of the presence, the absence and/or the intensity of the markers from the results of corrected spectrophotometric analysis,
determination of the authentication code of the object or the substance from the presence, the absence and/or the intensity of said markers.

Of course, this method could comprise emission of a validation signal in the event where correspondence was detected, or an alert signal in the event where the authentication code does not correspond with the identification code.

An advantage of this solution is that it permits utilisation of very slight concentrations (a few ppm to a few hundred, preferably a few tens of ppm or parts per million) of chemical markers each having a characteristic luminescent signal. Nevertheless, these concentrations can optionally attain several percent in the case of particular matrices, such as coloured or black. The result is:
The possibility of using nano-materials that is, particles or structures whereof the size is measured in nanometres (or billionths of metre) as chemical markers. Use is made here of the property relative to the fact that the smaller the size of the particles, the greater the surface/volume ratio and, as a consequence, the more significant the spectrophotometric analysis.
Considering the very small quantities used, the essential physical and chemical properties of the matrix in which the marker is added remain unchanged, a surface deposit by means of markers assimilable by the organism could thus be utilised to identify drugs and prevent fakes possibly dangerous to health.
For the same reason, the cost of the marker is low.
The signal emitted further to the lighting of the product or the substance is weak and is lost amid background noise. It is thus difficult to detect by those not equipped with a dedicated detector.
The signal is quasi impossible to imitate since it is weak and has a very precise wavelength with a specific peak width.
The intensity of the emission peak is a function of the concentration of the marker. It is almost impossible to duplicate manually a concentration of the order of several ppm, especially homogeneously. For example, if the original controlled concentration is 4.0 ppm, a copy will present variations from 0 to several tens or hundreds of ppm, avoiding carrying out a positive reading by the detector for which the acceptance criteria are narrow (3.8 to 4.2 ppm for example).
The difficulty in carrying out counterfeiting is made even more difficult when several markers are used whereof the signals are analysed independently then compared.
It is also possible to utilise decoys, that is, pseudo-markers, the purpose of the presence whereof is solely to mislead the counterfeiter.
The entity responsible for the implementing the method according to the invention could adapt the authentication codes, without altering the security of the process, even if the source of its tracers was known. It can choose its codes without the knowledge of its suppliers. It can also periodically modify its codes in the same way as a change is made to a password in an information system.
It becomes possible to consider several levels of coding with predetermined reading or authentication devices for reading a certain level only. Therefore, for example, a manufacturer could utilise three markers A, B and C, the markers A and B serving to identify a registered pattern, whereas the third marker corresponds to the production site.
The personnel in charge of checking the market for product authenticity will have a device designed for identification of markers A and B. The
“internal security” service or the quality service could utilise a device for detecting the marker C.
The markers could be:
   a) embedded in the mass: By way of example, these markers can be incorporated in a plastic matrix in which the purpose of the marker is to identify the title and the grade of the polymer, the producer, the traceability, the authentication of the object, etc.
   b) arranged on the surface, for example:
      by impregnation (for example in a textile, a chemical stain . . . ),
      by coating (varnishing, painting, pulverisation) on different supports, for example metallic aviation elements, whether on the entire surface or selectively (serigraphy, buffer deposit),
      in the form of marked labels in part visible or not.
   Similarly, the authentication code could be determined from the presence or the absence of markers embedded in the mass and the presence or absence of markers arranged on the surface, optionally on a label.

Advantageously, this label could comprise a reflecting zone covered by a transparent layer containing markers. This solution thus effects spectrophotometry by reflection, which considerably reduces energy losses.

The authentication data could comprise the combination of selected markers, the wavelengths of characteristic rays, their intensity, the duration of possible fluorescence . . . .

Therefore, it is not necessary to cover all the wavelengths, since it suffices to analyse the ranges of values corresponding to the expected stripes which are identified from the identification code so as to verify their presence or their absence without being preoccupied with the zones situated outside these ranges.

To proceed with authentication, the operator conducting the analysis has no need to know the theoretical identity of the object or the substance as it is provided by the bar code directly to the information system making the data comparison.

Advantageously, the marked zones could be conformed so as to make an invisible marking according to zones having well-defined forms.

In this case, the authentication method could comprise reading the marked zones coupled to a method for recognising forms, resulting in making counterfeiting even more random.

Such a method could be utilised in the struggle against counterfeiting, but likewise be applied to automatic screening. For example, in the case of recycling plastic, it could be possible to utilise a combination of markers by type of plastic or by grade of plastic, enabling it to be screened by type or by grade once authentication is done.

The reading devices utilised for implementing the method according to the invention could be portable for on-site checks or on points of sale. Nevertheless, batch checking during production can be also carried out due to the significant number of possible measures (up to 10,000 and to 100,000 measurements per second).

Embodiments of the invention will now be described hereinafter, by way of non-limiting examples.

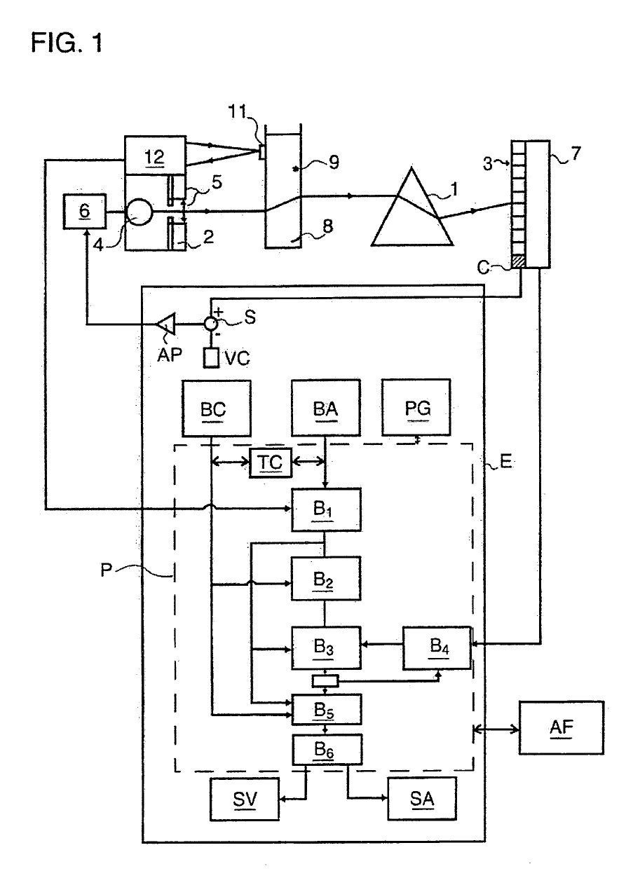

FIG. 1 is a schematic illustration of a device using the method according to the invention, the waves being transmitted;

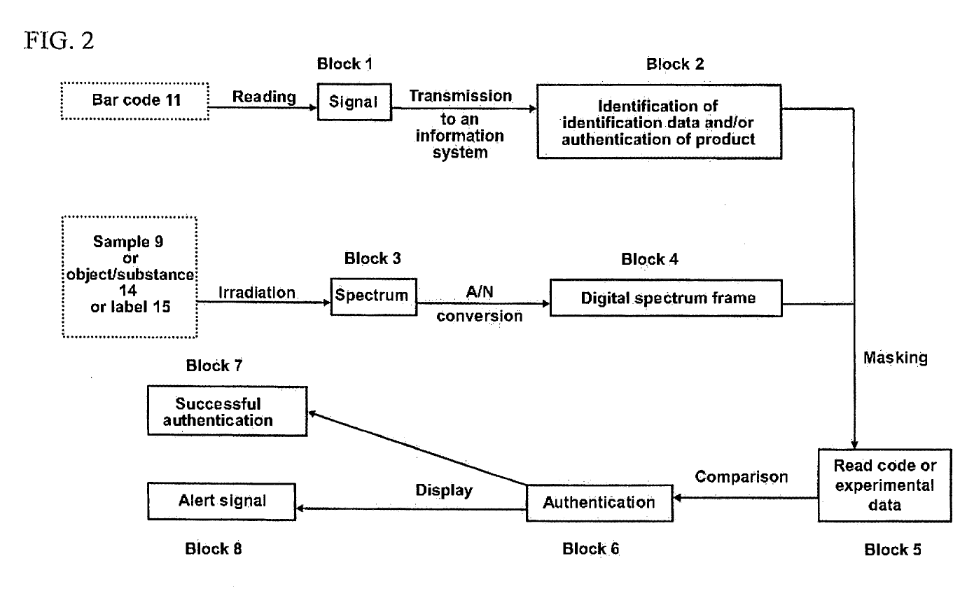

FIG. 2 is a functional diagram of the method according to the invention;

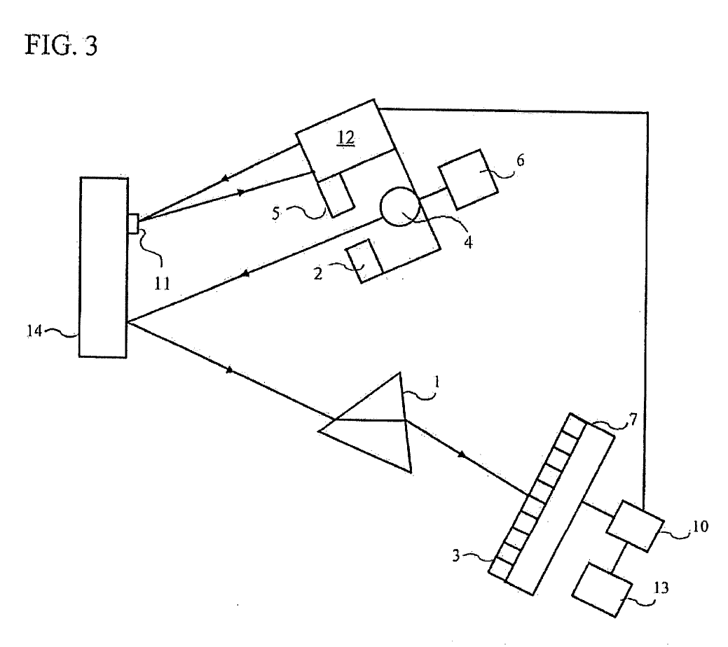

FIG. 3 is a schematic illustration of a device using the method according to the invention, the waves being reflected;

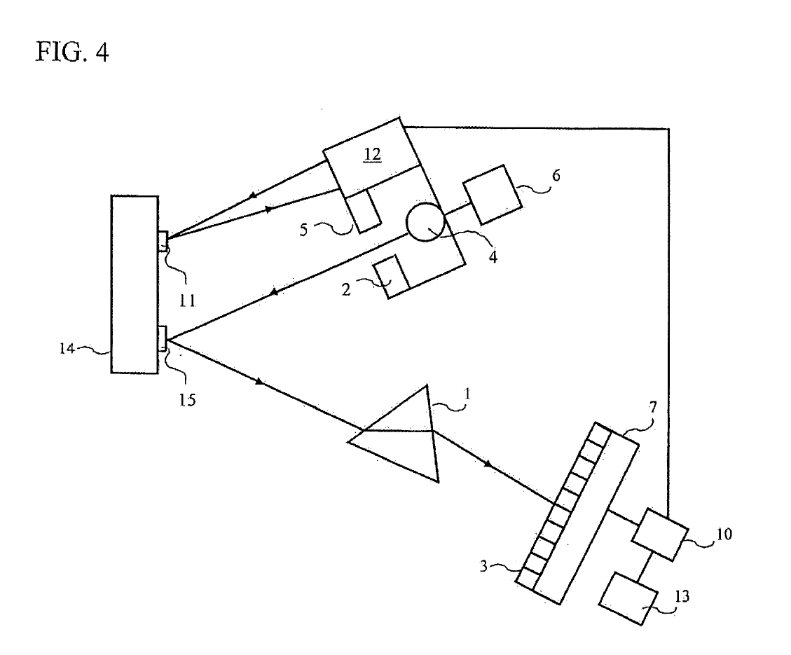

FIG. 4 is a schematic illustration of a device using the method according to the invention, the waves being reflected on a label.

In the example of FIG. 1, these are the waves transmitted across a substance containing a combination of markers and more exactly analysed on a sample eventually diluted in a solution.

It should be noted that this type of analysis can likewise be done on objects whereof the material allows this either directly or on the substance (solid or liquid) through its container.

In this example, the identification and authentication device utilising the method according to the invention comprises a spectrophotometer comprising:
a generator of light radiation of long-frequency spectrum and of adjustable intensity bringing in a light source 4 powered by an electric current generator 6 with adjustable power;
a collimator 2 in the axis of which is placed a lens 5,
a product sample 8 contained in a transparent container 9 located in the optical axis of the light generator,
a dispersive element 1 located in said axis to the side of the container 9 located opposite the light generator; this dispersive element 1 (prism or diffraction network) decomposes light radiation as a function of the frequency for producing a spectrum,
detection means for the spectrum, here a detector tag for transfer of DTC 3 charges for detecting the radiations emitted on different spectral levels by the dispersive element 1 and for transmitting to an electronic system a digital signal representative of the spectrum detected.

As previously mentioned, the light source 4 is a wide-frequency spectrum source. It can consist of arc lamps (of Xenon type) or a bulb generating white light. Optionally, it could consist of a plurality of sources of laser radiation specifically selected as a function of the nature of the chemical markers utilised, an optical mixer then being utilised for mixing the different radiations emitted by these sources.

The lens 5 can, for example, consist of an achromatic doublet.

Of course, the electric current generator 6 could likewise serve to power the electronic circuits connected to the spectrophotometer.

In this example, the detector tag 3 comprises a cell C located at a position of the spectrum not affected by the presence of the chemical markers.

This cell C emits a detection signal applied (after amplification) to the input of a subtracter S whereof the second input receives calibrated voltage VC. The output of this subtracter S is applied to a power amplifier AP which runs the generator 6 such that the output of the subtracter S is maintained at a constant value, preferably equal to zero.

Because of this disposition, it is ensured that the level of light intensity received by the cell C is constant. This therefore avoids any perturbations likely to vary the light intensity of the radiation transmitted through the sample 8.

In keeping with the invention, the light source is associated with a bar code reader 12, which emits light radiation (for example laser) in the direction of a bar code 11 borne by the container 9. This reader 12 comprises a receiver for detecting the radiation reflected by the bar code. An electronic circuit processes the information received by this receiver and generates a digital signal representative of this bar code destined for the electronic system E.

The electronic system comprises a processor P (indicated in dashes) associated with storage means of a database of the identification codes BC, a database of the authentication codes BA and a management program for the different processings PG, as well as display and signalling means AF.

This processor P is designed so as to conduct theoretical identification (block B1) of the container 9 from the signal delivered by the bar code reader 3, from the database of the identification codes BC. Once theoretical identification is complete, the processor P determines the zones of the spectrum to be explored (block B2). For this purpose, it utilises, apart from the identification read code, the corresponding authentication code due to a correspondence table TC compiled between the two databases BC, BA. The processor P then analyses (block B3) the previously determined zones of the spectrum via the signal provided by the detector tag 3.

In the event where a standard measure marker is used, this signal can be corrected (block B4) prior to analysis from the digital signal produced by the detector corresponding to this standard measure marker.

The processor P then determines (block B5) the detected authentication code, which it compares (block B6) to the predetermined identification code. In the case of concordance between these two codes, the processor emits a validation signal SV. On the contrary, the processor emits an alarm signal SA.

The method according to the invention utilised by the device illustrated in FIG. 1 comprises the following phases (FIG. 2):
An initial phase comprising:
   selection of markers as a function of their adequacy relative to one another and relative to the substance,
   introduction of these markers to different concentrations in said substance,
   determination of the authentication codes constituted by binary figures representative of the presence or the absence, even the concentration of the markers, these codes being stored in memory in the electronic system E,
   attribution to each of these codes of a substance identified by a bar code 11.
An identification and/or authentication phase comprising:
   reading of the bar code 11 located on the container of the marked substance by means of the bar code reader 12 and the emission of a specific signal containing an identification code of the substance (block 1),
   transmission of said signal to the electronic system E which identifies this identification code (block 2),
   spectrophotometric analysis comprising:
      irradiation of the substance by means of the source rays 4,
      transmission of the waves transmitted to the dispersive element 1 which deflects it differently as a function of their wavelength,
      obtaining a spectrum of the radiation transmitted due to the flat waves therefore deflected which give, in a detection zone composed of the series of DTC 3 tags, a succession of images of the source (block 3),
      sampling of this spectrum then conversion of the analog signal into a digital signal presenting a predetermined digital frame (block 4),
      masking carried out as a function of the ranges of wavelengths indicated in the authentication data stored in memory and extracted due to identification of the bar code, so as to consider only the presence or the absence of the characteristic stripes of the markers which then determines a read code (block 5),
      comparison of the data or authentication code to the experimental data or read code so as to carry out authentication of the substance (block 6),
   display of the result visually, for example on a screen 13 and/or by using audio means:
      successful authentication if there is coincidence between the authentication codes and the read code (block 7),
      alert signal in the event of non-authentication if there is a discordance between the authentication codes and the read code (block 8).

FIG. 3 illustrates analysis using waves reflected onto at least part of an object or a substance 14.

In this case, the dispersive element 1 is located on the axis of the reflected wave.

The method is the same as the one described hereinabove for the example of FIG. 1.

FIG. 4 illustrates a variant of the example of FIG. 3. In fact, the markers are not directly integrated in an object or a substance 14, but are applied by means of a film, a transparent varnish on a label 15, which is appended to the object to be marked.

The method is the same as that described hereinabove for the example of FIG. 1.

For a better analysis result, the label could be reflecting.

Also, using a blank label of any marker and optionally covered in a film or a varnish utilised for applying the markers can, during data processing, eliminate the corresponding signals and therefore simplify analysis. In fact, the marked label then the blank label, are irradiated, then, during data processing, the data of the spectrum of the blank label are removed from the data of the spectrum of the marked label.

In the case of fluorescent markers, it is an option to take a second measurement after a time δt so as to verify the duration of the fluorescence.

The tracers utilised can be organic or inorganic. They can be based on rare earths such as dysprosium, europium, samarium, yttrium . . . .

Some markers used and their characteristics are presented by way of example in the table below:

The companies marketing them are especially “BASF” (registered trade mark), “Bayer” (registered trade mark), “Glowburg” (registered trade mark), “Lambert Riviere” (registered trade mark), “Phosphor Technology” (registered trade mark), “Rhodia” (registered trade mark), SCPI, . . . .

| | | Wavelength of the |
|---|---|---|
| | Excitation wavelength | emission peak |
| Marker | λₑₓ + Δλ_{1/2} | λₑₘₐₓ + Δλ_{1/2} (nm) |
| A | 300 ± 40 | 480 ± 6 |
| | | 572 ± 6 |
| B | 300 ± 40 | 562 ± 10 |
| | | 601 ± 6 |
| C | 335 ± 35 | 470 ± 85 |
| D | 365 ± 70 | 480 ± 90 |
| E | 350 ± 20 | 612 ± 3 |
| F | 380 ± 45 | 480 ± 75 |
| G | 365 | 610 ± 50 |

It should be noted that the markers are not limited to commercial markers, and they can be synthesised by total synthesis or derived from commercial markers.

1. A method for identification and authentication of different objects or substances, this method utilising an information system coupled to spectrophotometry means, said method comprising at least the following two successive phases:
an initial phase comprising
the selection of a plurality of chemical markers which, when excited by incident light radiation, emit energetic radiations whereof the frequency spectra are discernible relative to one another and relative to the objects and substances in which they are intended to be incorporated,
the attribution then incorporation in each of the objects or substances of a combination of previously selected markers different to those attributed to the other objects,
the setting up of an authentication code determined by parameters relative to the presence or the absence of the markers in the attributed combinations,
the storing in memory of an information system of the authentication code of all the objects or substances and associated data corresponding to these objects or these substances,
the assignment to the object or the substance of an identification code, such as a bar code or similar, this identification code capable of being associated with the object, the substance, its container, and/or its packaging,
the storing in memory in said system of the identification codes of each of the objects,
the setting up of a correspondence between the identification codes and the authentication codes, and
an identification and authentication phase by said system, this phase comprising:
theoretical identification of the object or the substance by reading the identification code associated with the object,
spectrophotometric analysis of at least part of the object or the substance so as to detect the above-mentioned parameters, especially the presence or the absence of markers and determination of the authentication code of the object or the substance,
authentication of the object in the event where the theoretical identification code corresponds to the authentication code,
emission of a validation signal in the event where correspondence has been detected or an alert signal in the event where the authentication code does not correspond with the identification code.

2. The method as claimed in claim 1, wherein the concentration of markers utilised is of the order of several ppm to several hundreds of ppm, preferably several tens of ppm.

3. The method as claimed in claim 2, wherein the abovementioned markers comprise nano-materials producing characteristic light signals.

4. The method as claimed in claim 1, further comprising the utilisation of markers serving as decoys.

5. The method as claimed in claim 1, wherein the authentication code of a same product is periodically modified.

6. The method as claimed in claim 1, comprising selection of the markers by levels of intensity.

7. The method as claimed in claim 1, wherein the markers assigned to a same object or to a same substance define several codes legible by different reading means.

8. The method as claimed in claim 1, wherein the abovementioned markers are embedded in the mass or arranged on the surface.

9. The method as claimed in claim 1, wherein the authentication code is determined from the presence or the absence of markers embedded in the mass and markers arranged on the surface.

10. The method as claimed in claim 1, comprising according to one or more zones presenting well-defined forms, and in that the authentication phase comprises reading the zones marked with recognition of said forms.

11. The method as claimed in claim 1, wherein said spectrophotometric analysis comprises the following stages:
irradiation of the object or the marked substance by means of a wide-frequency spectrum light beam,
sending waves transmitted or reflected by the object or the substance emitted by a generator on a dispersive element which deviates it so as to produce a light spectrum of the light intensity in different zones of the spectrum corresponding to ranges of different wavelengths,
detection of the light intensity in each of the zones,
comparison of this intensity with one or more threshold values specifically attributed to this zone and which are registered in memory by way of the abovementioned parameters,
result of this comparison contributing to determination of the authentication code of the object.

12. The method as claimed in claim 11, comprising determination of the abovementioned zones of the spectrum to be analysed, as well as different parameters assigned to each of these zones, from the abovementioned identification codes.

13. The method as claimed in claim 11, comprising control of the light intensity emitted by the generator of light radiation, as a function of the spread between the value of the light intensity detected, in a predetermined frequency range not affected by the presence of the markers, and a predetermined deposit value.

14. The method as claimed in claim 11, wherein the abovementioned generator of light radiation comprises a wide-frequency spectrum light source such as an arc lamp or an ampoule generating white light.

15. The method as claimed in claim 11, wherein the abovementioned generator of light radiation comprises a plurality of sources of laser radiation specifically selected as a function of the nature of the chemical markers utilised, and a mixer serving to mix the different radiations emitted by these sources.

16. The method as claimed in claim 11, wherein said spectrophotometric processing of the analysis data comprises the following stages:
the sampling of the spectrum,
the conversion of the analog signal to a digital signal presenting a predetermined frame (block 4),
the masking as a function of the ranges of wavelengths indicated in the authentication data stored in memory and extracted due to identification of the bar code, so as to determine a read code with the abovementioned parameter (block 5),
the comparison of the authentication data to the experimental data or read code (block 6),
the display of the result visually and/or by using audio means so as to indicate:
a successful authentication if there is coincidence between the authentication codes and the read code (block 7),
an alert in the event of non-authentication if there is discordance between the authentication codes and the read code (block 8).

17. The method as claimed in claim 11, comprising the insertion of a reflecting support containing the marker or markers.

18. The method as claimed in claim 11, comprising the insertion of a blank support of any marker, this support being likewise irradiated then, during data processing, the data of the spectrum of the blank support being removed from the data of the spectrum of the support marked so a to eliminate the corresponding signals and therefore simplify analysis.

19. The method as claimed in claim 1, wherein during data processing, the data of the spectrum of the object or the blank substance of markers are removed from the data of the spectrum of the object or the marked substance.

20. The method as claimed in claim 1, wherein said combination of markers comprises at least one fluorescent marker.

21. The method as claimed in claim 18, wherein said parameters also comprise the duration of the light emission of the substance to be identified further to excitation.

22. The method as claimed in claim 21, wherein parameters comprise:
the presence or not of fluorescence,
a duration of fluorescence greater or less than a threshold value,
the presence or the absence of a peak having a preset wavelength and/or,
heights of emission peak corresponding to a concentration of markers greater or less than a predefined threshold value.
